(19) United States
(12) Patent Application Publication
(10) Pub. No.: US 2023/0194891 A1
(43) Pub. Date: Jun. 22, 2023

(54) MONOCOQUE SMART GLASSES TEMPLE PRE-FORM

(71) Applicant: GOOGLE LLC, Mountain View, CA (US)

(72) Inventors: Jiwon Yang, Toronto (CA); Joshua Moore, Elora (CA); Eric Anthony Bokides, Boise, ID (US); James Nelson Castro, San Jose, CA (US)

(21) Appl. No.: 17/645,150

(22) Filed: Dec. 20, 2021

(51) Int. Cl. G02C 5/14; G02C 11/00

(52) U.S. Cl. CPC G02C 5/146; G02C 11/10

(57) ABSTRACT

A method for making smart glasses includes obtaining a temple pre-form made as a one-piece seamless shell structure with shell walls enclosing a hollow compartment. An opening at one end of the one-piece seamless shell structure provides physical access to insides of the hollow compartment. The method further includes disposing one or more smart glasses components in the hollow compartment through the opening in the shell structure, and attaching the temple pre-form with the one or more smart glasses components disposed in the hollow compartment to a frame of the smart glasses.

### FIELD

This disclosure relates to smart glasses that provide additional information alongside what a wearer sees through the glasses.

### BACKGROUND

Smart glasses (including, e.g., Optical Head-Mounted Display (OHMD), Augmented Reality (AR) glasses, or through Heads Up Display Glasses (HUD)) are wearable devices that add information onto a user's field of view. Electronic and optical components of the smart glasses (e.g., electronic components such as processors, wireless transceivers, batteries, control buttons, in-lens or attached displays, etc.; audio components such as speakers, microphones, etc.; and optical components such as prisms, projectors, and cameras, etc.) (hereinafter “smart glasses components”) can generate and display additional information (e.g., on an in-lens display) alongside what the wearer sees through the glasses. Several of these smart glasses components are typically either attached to and protrude from a wearable frame of the smart glasses, or are enclosed in bulky box-like structures (i.e., legs) attached to the frame. Consumers can find the smart glasses with bulky component structures unusual or uncomfortable to wear all day, and may prefer the shape, size, and form factor of regular glasses (e.g., regular glasses that are fashionably slim and stylish). However, even with increasing miniaturization of the components, the large number of smart glasses components needed to make the smart glasses function makes it challenging to balance functionality and wearability of the smart glasses.

Consideration is now being given to smart glasses that can have a large number of components fitted in a slim design or form factor.

### SUMMARY

In a general aspect, a temple pre-form is used for constructing a smart glasses temple. The temple pre-form includes a one-piece seamless shell structure having shell walls enclosing a hollow compartment. An opening at one end of the one-piece seamless shell structure provides physical access to an inside volume of the hollow compartment.

In a further aspect, one or more smart glasses components are placed in the hollow compartment through the opening in the shell structure, and the temple pre-form with the one or more smart glasses components disposed in the hollow compartment is attached to a frame of the smart glasses.

in a general aspect, a method for making smart glasses includes obtaining a temple pre-form made as a one-piece seamless shell structure with shell walls enclosing a hollow compartment. An opening at one end of the one-piece, seamless shell structure provides physical access to insides of the hollow compartment. The method further includes disposing one or more smart glasses components in the hollow compartment through the opening in the shell structure, and attaching the temple pre-form with the one or more smart glasses components disposed in the hollow compartment to a frame of the smart glasses.

### BRIEF DESCRIPTION OF THE DRAWINGS

Example embodiments will become more fully understood from the detailed description herein and the accompanying drawings, wherein like elements are represented by like reference numerals, which are given by way of illustration only and thus are not limiting of the example embodiments.

FIG. 1 illustrates an example pair of smart glasses.

FIG. 2 illustrates an aspect of an example monocoque one piece tube-like temple pre-form for smart glasses, in accordance with the principles of the present disclosure.

FIG. 3 illustrates a further aspect of the example monocoque one piece tube-like temple pre-form of FIG. 2, in accordance with the principles of the present disclosure.

FIG. 4 illustrates another aspect of the example monocoque one piece tube-like temple pre-form of FIG. 2, in accordance with the principles of the present disclosure.

FIG. 5 illustrates yet another aspect of the example monocoque one piece tube-like temple pre-form of FIG. 2, in accordance with the principles of the present disclosure.

FIG. 6 illustrates an example method for making slim smart glasses, in accordance with the principles of the present disclosure.

It should be noted that these FIGS. are intended to illustrate the general characteristics of methods, structures, and/or materials utilized in certain example embodiments and to supplement the written description provided below. These drawings are, however, not to scale and may not precisely reflect the precise structural or performance characteristics of any given embodiment, and should not be interpreted as defining or limiting the range of values or properties encompassed by example embodiments. For example, the relative thicknesses and positioning of components of the described eyeglasses may be reduced or exaggerated in the drawings for clarity. The use of similar or identical reference numbers in the various drawings is intended to indicate the presence of a similar or identical element or feature.

### DETAILED DESCRIPTION

Smart glasses can be eyewear (i.e., a pair of glasses, also known as glasses, eyeglasses or spectacles) configured as a vision aid. The smart glasses can consist of glass or hard plastic lenses mounted in a frame that holds them in front of a person's eyes, typically utilizing a nose bridge over the nose, and arms (known as temples or temple pieces) that rest over the ears. In general, the smart glasses eyewear may include prescription glasses, reading spectacles, non-prescription glasses, fashion eyewear (tinted and clear), sunglasses, ski and safety goggles, and more. For example, the eyewear can be smart glasses that can add information (e.g., augmented reality (AR) information including text, audio and/or video information) alongside what the wearer sees through the glasses.

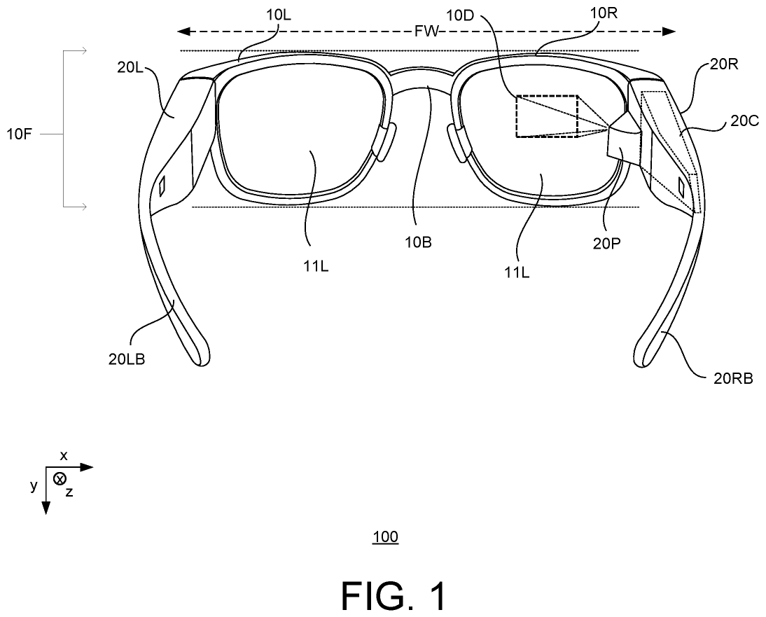

FIG. 1 illustrates example smart glasses (e.g., glasses 100) that can add information (e.g., on an in-lens display 10D) alongside what a wearer views through the glasses.

Glasses 100 may be a wearable, voice- and/or motion-controlled device that resembles a pair of eyeglasses and displays information directly in the wearer's field of vision. Glasses 100 may include two half-frames 10R and 10L to hold a pair of see-through lenses (e.g., lenses 11L) in front of a person's eyes. In some example implementations, a virtual display (e.g., display 10D) may be overlaid on, or embedded in, at least one of the pair of see-through lenses 11L held in the two half-frames 10R and 10L. In some implementations, display 10D may be a projected display on which additional information can be optically projected alongside what the wearer views through the glasses. In some implementations, display 10D may be an in-lens micro display.

The two half-frames 10R and 10L may be joined using wires or bands made of plastic, metal or wood, and/or other joining means to form a spectacle frame 10F (hereinafter “frame”, or “eyeglasses frame”). The joining means can include a nose bridge portion (e.g., nose bridge 10B). Spectacle frame 10F may have a front width FW (e.g., in an x direction) that may be selected to match, for example, an ear-to-ear face width of the person using the eyewear.

Further, glasses 100 may include temples (arms) (e.g., a right temple 20R and a left temple 20L) that are attached to respective ends of the two half-frames 10R and 10L. Right temple 20R and left temple 20L may extend generally perpendicular to the two half-frames 10R and 10L, for example, in a y-direction. Each of the temples (e.g., right temple 20R and left temple 20L) may have a length extending from the front portion of the frame (i.e., frame 10F) sufficient for the temples to reach over resting positions on the person's ears when frame 10F is positioned in front of the person's eyes. In some implementations, each of the temples (e.g., right temple 20R and left temple 20L) may include respective bent portions (e.g., right temple bend 20RB and left temple bend 20LB, respectively) that can be curved behind the person's ears, for example, to hold the glasses in place (e.g., to prevent the glasses from sliding forward) when the person's head is tilted downward.

In some example implementations, one or both of the two temple pieces 20L and 20R attached to eyeglasses frame 10F may include a compartment (e.g., compartment 20C) to hold electronics and other optical, mechanical, and electrical components (hereinafter smart glasses components”) (not shown) of the smart glasses. The smart glasses components held in compartment 20C may, for example, include one or more of processors, control circuits, batteries, optical projectors, optical windows, speakers, microphones, audio meshes, heat spreaders, sensors, or other circuitry, and may be used to add information (e.g., on display 10D) alongside what the wearer views through the glasses and or sense information from around the glasses. In some implementations, some of the smart glasses components (e.g., a projector 20P) may protrude from a side of the temple. FIG. 1 shows, for example, projector 20P protruding from a side of temple 10R. Projector 20P that may be configured to project information on display 10D.

In example implementations, spectacle frame 10F and temples 20L and 20R may be made from plastics or polymeric materials (e.g., including thermoplastic materials such as polypropylene, polyethylene, polyvinylchloride, polystyrene, polyethylene terephthalate (PET), or polycarbonate, etc.). The adjustable bent portions (e.g., right temple bend 20RB and left temple bend 20LB, respectively) of the temples may, for example, include stiffening metal wire or rods encased in plastic or epoxy (not shown).

In traditional implementations, temples 10L and 10R may be assembled from multiple pieces or parts. Each temple may, for example, have a structure assembled from multiple pieces (e.g., a clam shell structure, a box-with-lid structure, or a two-part structure with front and back halves) and the required sealing surfaces, gaskets, adhesives, etc., to enclose a waterproof compartment (e.g., compartment 20C) in which the smart glasses components are held. The temple structures may be assembled by joining the multiple pieces (using, e.g., lap joints) to form the compartments (e.g., compartment 20) in the body of the temples to hold the smart glasses components. The lap joints may then be sealed to waterproof the compartment using, for example, a waterproof sealant (e.g., an O-ring, gasket, epoxy, or adhesive, etc.). The temple structures constructed from the multiple pieces can have significant wall and waterproof-sealed lap joint thicknesses. For example, a typical plastic wall thickness may be about 0.8 mm and a typical waterproof-sealed lap joint thickness may be about 1.4 mm. These wall and lap joint thicknesses can be a significant proportion of the temple volume. For example, for a temple with cross-sectional dimensions of 10×5 sqmm, the wall and lap joint seals may take up 15-20% of the internal volume of the temple.

Furthermore, one or more adjustable items (e.g., bent portions such as right temple bend 20RB and left temple bend 20LB, windows and meshes, etc.) may be attached or added to the multi-piece temples as separate components. These adjustable items, which may be added to the temple structures using additional hardware (e.g., screws, adhesives, clips, snaps, welds, etc.), also consume a fraction of the temple volume.

There is a consumer demand for slimmer temples and at the same time for the temples to include more and more optical, mechanical, and electrical components. However, the traditional multi-piece temple structures (e.g., clam shell, box-with-lid, etc.) do not lend themselves to the construction of slimmer temples (which are more comfortable and desired by users) without also sacrificing the volume of the compartment (e.g., compartment 20C) for holding the smart glass components.

A monocoque (i.e., one piece) shell or tube-shaped temple structure (“monocoque temple”) for making slim smart glasses is disclosed herein. The monocoque temple has a one-piece seamless shell (tube) structure that can have ultra-thin shell (tube) walls. The shell (tube) walls enclose a hollow compartment to hold smart glasses components. The monocoque temple may be made of plastic or plastic composite materials, or metals such as aluminum or titanium. In example implementations, the monocoque temple may be fabricated using, for example, injection molding or compression molding to form the hollow tube-like shell of the monocoque temple.

In example implementations, the thicknesses of the shell walls of the tube-shaped monocoque temple surrounding the hollow enclosed compartment may have a thickness T. In some implementations, the thickness T may be less than about 1.0 mm. In some implementations, the thickness T may be between about 0.3 mm and 0.4 mm (e.g., less than half the thickness of walls in traditional multi-piece temples (FIG. 1)).

In example implementations, openings or apertures may be formed (e.g., machined) in the monocoque shell structure to accommodate externally accessible interfaces of the smart glasses components (e.g., optical windows, speaker and microphone meshes, control buttons, etc.) that may be held in the enclosed compartment.

In some implementations, a temple bend may be seamlessly integrated with the hollow tube-like shell of the monocoque temple. A core wire (e.g., a stainless or titanium wire) may be placed or embedded in a portion of the temple (e.g., a temple bend section) to provide mechanical strength and support for the temple bend, which may be flexible and adjustable (e.g., curved behind the ear of a person).

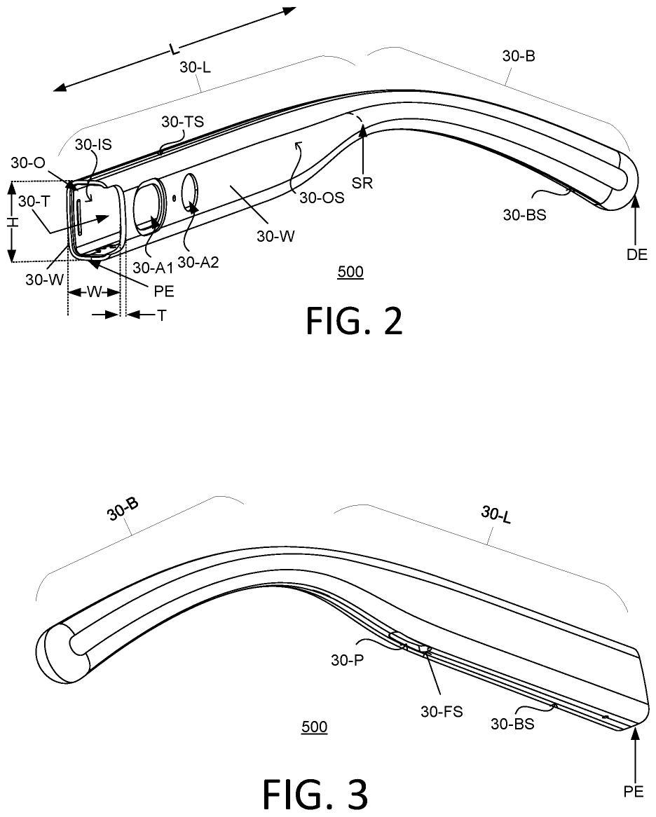

FIGS. 2, 3, 4, and 5 illustrate aspects of an example one piece tube-like temple pre-form 500 that may be used to construct monocoque temples of smart glasses with a slim design or form, in accordance with the principles of the present disclosure.

Temple pre-form 500 includes a tube-like compartment or enclosure (e.g., enclosure 30T) that can be filled with one or more smart glasses components (e.g., processors, control circuits, batteries, optical projectors, speakers, microphones, etc.) needed for functioning of the smart glasses. Temple pre-form 500 may be made of molded plastic materials, for example, by injection molding or compression molding of the plastic materials.

The example temple pre-form 500 may be used, for example, to construct a right temple of a pair of smart glasses (e.g., replacing right temple 20R, FIG. 1 with a slimmer design). A similar temple pre-form (e.g., a mirror image) (not shown) may be used to construct the left temple of the pair of pair of smart glasses.

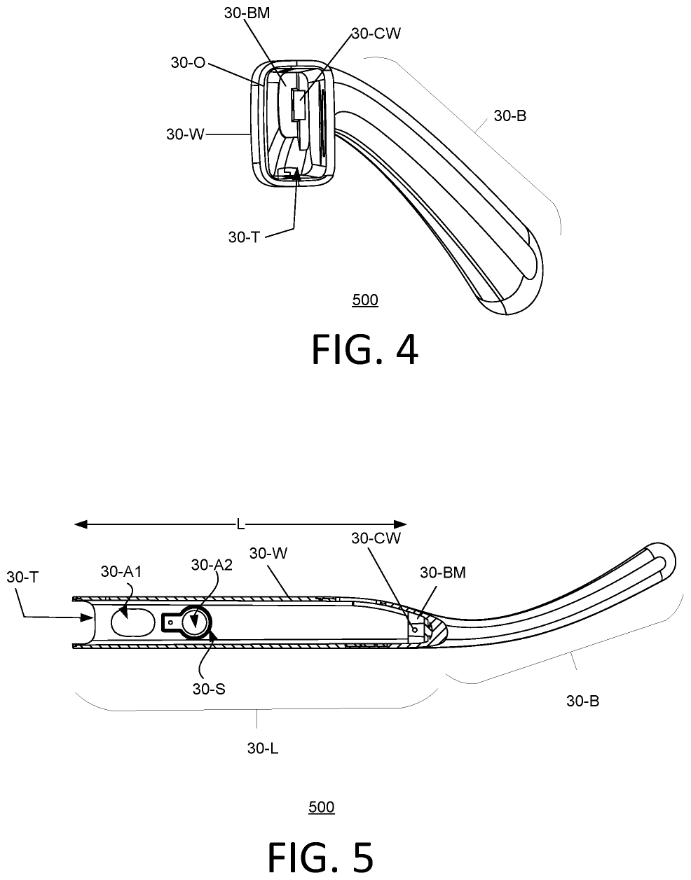

FIG. 2 illustrates a side perspective view looking down on temple pre-form 500, while FIG. 3 illustrates a side perspective view looking up toward temple pre-form 500. FIG. 4 illustrates an end view of temple pre-form 500, and FIG. 5 illustrates a cutout portion of temple pre-form 500.

As shown in FIGS. 2, 3, 4 and 5, temple pre-form 500 includes a substantially straight or linear section (e.g., linear section 30-L) extending from a proximal end PE toward a bend section 30-B ending at a distal end DE. Linear section 30-L of temple pre-form 500 may include an open-ended tube-like enclosure 30-T that is formed between thin walls (e.g., walls 30-W) of the linear section 30-L. Enclosure 30-T may have any three dimensional shape (e.g. a cylinder with a round cross-section, a rectangular cross-section, or a rounded rectangular cross-section, etc.). A cross-section of enclosure 30-T may, for example, have a rectangular, square, trapezoidal, oval or circular shape.

In example implementations, enclosure 30-T may have a length L and a generally rectangular cross-section having a height H and a width W. In example implementations, height H and width W may each be a few mms in size. In an example implementation, H may be equal to about 16 mm and W may be equal to about 10 mm.

In example implementations, walls 30-W may have a thickness T that is less than 0.5 mm in dimension. In an example implementation, the thickness T may, for example, be between about 0.3 and 0. 4 mm or less as may be determined by the materials and the manufacturing processes used. In example implementations, the walls (e.g., walls 30-W) may form the outside surfaces (e.g., outside surface 30-OS, bottom surface 30-BS, and top surface 30TS) of enclosure 30-T and temple pre-form 500. Further, the thin walls (e.g., walls 30-W) may form the inner surfaces (e.g., inner surface 30-IS) of enclosure 30-T and temple pre-form 500. In example implementations, the inside and outside surfaces (e.g., inside surface 30-IS and outside surface 30-OS) may be prepared with standardized Society of Plastic Industry (SPI) surface finishes. For example, inside surface 30-IS may have a standard SP1 A2 surface finish or texture, and outside surface 30-OS may have a standard SP1 A1 surface finish or texture.

In example implementations, the inside volume of enclosure 30-T may be physically accessible through an opening (e.g., opening 30-O) at the proximal end PE of temple pre-form 500. Opening 30-O may be configured to allow insertion and placement of smart glasses components (e.g., microphone, speakers, projectors, etc.) (not shown in FIG. 2) in enclosure 30-T of temple pre-form 500.

The proximal end PE of temple pre-form 500 (including opening 30-O) may be shaped to geometrically match and attach to a frame (e.g., half frame 10R, FIG. 1) of smart glasses (e.g., via hinge, clip or stub mechanisms (not shown)), for example, after the smart glasses components have been deployed in temple pre-form 500.

In example implementations, additional openings or apertures (e.g., aperture 30-A1, 30-A2, etc.) may be formed (e.g., machined or milled) in the walls of enclosure 30-T to accommodate placement of externally accessible interfaces of smart glasses components held in enclosure 30-T. The smart glasses components that may have externally accessible interfaces may include, for example, audio-related components such as microphone meshes and speakers, and optics-related components such as ambient light sensors, and optical projection devices.

In an example implementation (shown in FIG. 3), temple pre-form 500 may include an optics-related structure (e.g., structure 30-P) protruding from enclosure 30-T through a bottom surface (e.g., surface 30-BS) of temple pre-form 500. Structure 30-P may include an optical window, for example, a flat screen element (e.g., element 30-FS) through which light may be received in enclosure 30-T (e.g., for ambient light sensing), or emitted from enclosure 30-T (e.g., by a light projector) for display in the smart glasses. In example implementations, element 30-FS may have dimensions of the order of one millimeter or less (e.g., 0.6 mm to 1 mm). Structure 30-P may be oriented so that the optical window (e.g., element 30-FS) faces the proximal end (PE) of temple pre-form 500.

In example implementations, the open-ended tube-like enclosure 30-T formed between the thin walls (e.g., walls 30-W) of temple pre-form 500 may extend from the proximal end (PE) through the linear section 30-L only up to about a starting region or point (marked, e.g., as point SR in FIG. 2) of bend section 30-B. In example implementations, a body volume of bend section 30-B may be filled with a solid material (e.g., plastic or epoxy, material 30-BM, FIG. 4), and a core wire 30-CW may be embedded in the solid material. Core wire 30-CW may provide mechanical support and elasticity to bend section 30-B, which may be flexible and adjustable (e.g., behind the ear of a person). In example implementations, core wire 30-CW may be made, for example, from stainless steel, titanium, or other metal or metal alloy.

FIG. 4 illustrates temple pre-form 500 as viewed in enclosure 30-T through opening 30-0. FIG. 4 shows, for example, an end view of core wire 30-CW embedded in the body (e.g., material 30-BM) of bend section 30-B.

Further, for purposes of illustration, FIG. 5 shows a side view of temple pre-form 500 with a portion of linear section 30-L cutaway to expose features enclosed in enclosure 30-T. FIG. 5, like FIG. 4, shows an end of core wire 30-CW embedded in the body (e.g., material 30-BM) of bend section 30-B. FIG. 5 also shows a smart glasses component device (e.g. speaker 30-S positioned in enclosure 30-T above, for example, aperture 30-A2.

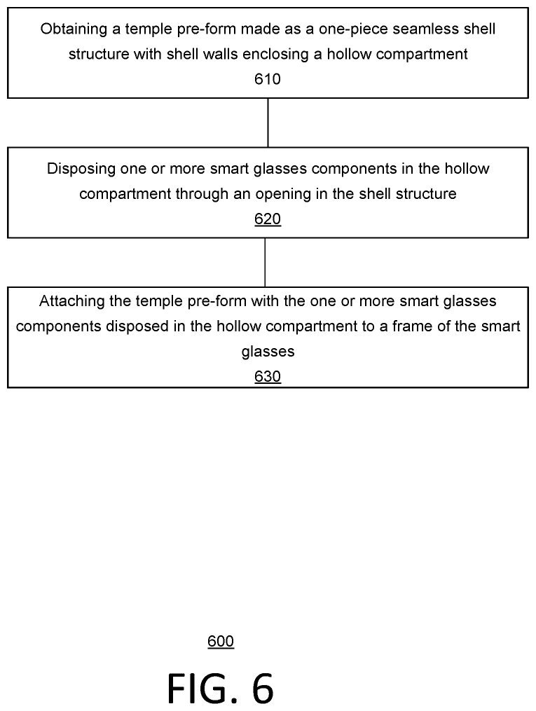

FIG. 6 illustrates an example method 600 making smart glasses with a slim temple design, in accordance with the principles of the present disclosure.

Method 600 includes obtaining a temple pre-form (e.g., temple pre-form 500) made as a one-piece seamless shell structure with shell walls enclosing a hollow compartment (610). An opening at one end of the one-piece seamless shell structure provides physical access to an inside volume of the hollow compartment.

Method 600 further includes disposing one or more smart glasses components in the hollow compartment through the opening in the shell structure (620), and attaching the temple pre-form with the one or more smart glasses components disposed in the hollow compartment to a frame of the smart glasses (630).

In example implementations, the shell walls of the seamless shell structure enclosing the hollow compartment may have a thickness equal to or less than about 1.0 mm (e.g., equal to or less than about 0.4 mm).

In example implementations, the hollow compartment may have a length between about 60 mm and 100 mm, a width (perpendicular to the length) equal to or less than about 10 mm (e.g., equal to or less than about 8 mm), and a height (perpendicular to the length and the width) equal to or less than about 20 mm (e.g., equal or less to about 12 mm).

In example implementations, disposing one or more smart glasses components in the hollow compartment through the opening in the shell structure 620 includes disposing at least one of a speaker, a microphone, an audio mesh, an on-off button, an optical window, a laser, a battery, a sensor, a heat spreader, and an electronic component in the hollow compartment.

In example implementations, the shell walls enclosing the hollow compartment can include one or more apertures adapted to provide an externally accessible interface to a smart glasses component held in the hollow compartment (e.g., the smart glasses component being one of a speaker, a microphone, an on-off button, and an optical window, etc.).

While example embodiments may include various modifications and alternative forms, embodiments thereof are shown by way of example in the drawings and description herein. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor (e.g., a processor formed on a silicon substrate, a GaAs substrate, and the like) or some other programmable data processing apparatus.

Some of the above example embodiments are described as processes or methods depicted as flowcharts. Although the flowcharts describe the operations as sequential processes, many of the operations can be performed in parallel, concurrently or simultaneously. In addition, the order of operations can be re-arranged. The processes can be terminated when their operations are completed, but may also have additional steps not included in the figure. The processes may correspond to methods, functions, procedures, subroutines, subprograms, etc.

Methods discussed above, some of which are illustrated by the flow charts, can be implemented by hardware, software, firmware, middleware, microcode, hardware description languages, or any combination thereof. When implemented in software, firmware, middleware or microcode, the program code or code segments to perform the necessary tasks can be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements can be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an, and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

The terms “substantially,” “nearly,” and “about” may be used herein to describe and account for small fluctuations, such as due to variations in processing or assembly. For example, these terms can refer to less than or equal to ±5%, less than or equal to ±2%, less than or equal to ±1%, less than or equal to ±0.5%, less than or equal to ±0.2%, less than or equal to ±0.1%, or less than or equal to ±0.05%. Also, when used herein, an indefinite article “a” or “an” means “at least one.”

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that can be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium can be magnetic (e.g., a floppy disk or a hard drive) or optical (e.g., a compact disk read only memory, or CD ROM), and can be read only or random access. Similarly, the transmission medium can be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. A temple pre-form for constructing a smart glasses temple, the temple pre-form comprising:
a one-piece seamless shell structure having shell walls enclosing a hollow compartment; and
an opening at one end of the one-piece seamless shell structure providing physical access to an inside volume of the hollow compartment.

4. The temple pre-form of claim 1, wherein the shell walls enclosing the hollow compartment are made of injection molded or compression molded thermoplastic materials.

3. The temple pre-form of claim 1, wherein the shell walls enclosing the hollow compartment have a thickness of less than about 1.0 mm.

4. The temple pre-form of claim 1, wherein the hollow compartment has a cylindrical shape with a rectangular, a square, a trapezoidal, an oval, or a circular cross-section.

5. The temple pre-form of claim 4, wherein the hollow compartment has a length between about 60 mm and 100 mm, a width perpendicular to the length equal to or less than about 10 mm, and a height perpendicular to the width and length equal to or less than about 20 mm.

6. The temple pre-form of claim 5, wherein the hollow compartment has a rectangular cross-section perpendicular to the length.

7. The temple pre-form of claim 1, wherein the hollow compartment is adapted to receive and hold a smart glasses component received through the opening, the smart glasses component being one of a speaker, a microphone, an audio mesh, an on-off button, an optical window, a laser, a battery, a sensor, a heat spreader, and an electronic component.

8. The temple pre-form of claim 1, wherein the shell walls enclosing the hollow compartment include one or more apertures adapted to provide an externally accessible interface to a smart glasses component held in the hollow compartment, the smart glasses component being one of a speaker, a microphone, an on-off button, and an optical window.

9. The temple pre-form of claim 1, further comprising:
a structure protruding from the hollow compartment through a surface of the temple pre-form, the protruding structure including an optical window through which light is received in, or exits, the hollow compartment.

10. The temple pre-form of claim 9, wherein the optical window is a flat screen element having a thickness of about one millimeter or less.

11. The temple pre-form of claim 1, wherein the one-piece seamless shell structure includes a substantially straight temple section and a temple bend section, the straight temple section extending from the opening toward and transitioning into, the temple bend section, the straight temple section being adapted to rest on an ear of a person and the temple bend section being adapted to be curved behind the ear of the person.

12. The temple pre-form of claim 11, wherein the straight temple section includes the hollow compartment.

13. The temple pre-form of claim 11, wherein the temple bend section includes a core wire embedded in plastic or epoxy material filling a body volume of the temple bend section.

14. The temple pre-form of claim 11, wherein the core wire is made of one of stainless steel, titanium, a metal, or a metal alloy.

15. A method for making smart glasses, the method comprising:
obtaining a temple pre-form made as a one-piece seamless shell structure with shell walls enclosing a hollow compartment, an opening at one end of the one-piece seamless shell structure providing physical access to insides of the hollow compartment;
disposing one or more smart glasses components in the hollow compartment through the opening in the shell structure; and
attaching the temple pre-form with the one or more smart glasses components disposed in the hollow compartment to a frame of the smart glasses.

16. The method of claim 15, wherein the shell walls of the seamless shell structure enclosing the hollow compartment have a thickness equal to or less than about 1.0 mm.

17. The method of claim 15. wherein the hollow compartment has a length between about 60 mm and 100 mm.

18. The method of claim 17, wherein the hollow compartment has a width and a height perpendicular to the length, and wherein the width is equal to or less than about 10 mm, and the height is equal to or less than about 20 mm.

19. The method of claim 15, wherein disposing one or more smart glasses components in the hollow compartment through the opening in the shell structure includes disposing at least one of a speaker, a microphone, an audio mesh, an on-off button, an optical window, a laser, a battery, a sensor, a heat spreader, and an electronic component in the hollow compartment.

20. The method of claim 15, wherein the shell walls enclosing the hollow compartment include one or more apertures adapted to provide an external interface to a smart glasses component held in the hollow compartment, the smart glasses component being one of a speaker, a microphone, an on-off button, and an optical window.
